(19) United States
(12) Patent Application Publication
(10) Pub. No.: US 2007/0164178 A1
(43) Pub. Date: Jul. 19, 2007

(54) MOUNTING RECEPTACLE WITH INTERCHANGEABLE HUB

(76) Inventors: Christine D. Beilstein, Chicago, IL (US); William Scott Hughes, Chicago, IL (US); Kurt Allen Melzer, Chicago, IL (US); Gilberto Cavada JR., Melrose Park, IL (US); Michael F. DeRossi, Lindenhurst, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/275,565

(22) Filed: Jan. 17, 2006

(51) Int. Cl. F16M 11/00

(52) U.S. Cl. 248/200

(57) ABSTRACT

A mounting receptacle is disclosed that selectively receives an interchangeable hub having a port therein, the port receiving an interface plug. The mounting receptacle may be installed in an opening in an article, such as an organizational device and, when a hub is received in the mounting receptacle, the port of the hub is accessible from an exterior of the article. The mounting receptacle may also be provided as a free-standing mounting receptacle.

### BACKGROUND

1. Field of the Disclosure

This disclosure is generally related to support structures for hubs for plugging in electrical, electronic, and communications devices and, more specifically, to modular securement of interchangeable hubs for plugging in electrical, electronic, and communications devices.

2. Discussion of the Related Art

As computer and communication technology advance, more varieties of peripheral devices are developed. The consumer market for these various computer, communication and peripheral devices is very large and many consumers own one or more of such devices. As the consumer acquires such devices, storage becomes problematic, especially because such devices often need to communicate with one another and thus are usually stored in close proximity to each other so as to be connected together for communication and/or integration.

Often, the most logical location to store such devices is on a desktop or at a workstation. Because a computer is usually a primary device, most consumers store the computer on a desk. While a desk provides a comfortable workstation, a desk top is limited in storage space. Often a monitor and keyboard may require most of the desktop space.

To solve this problem, many storage devices have been developed, for example, trays, sorters, shelves, stands, bridges, towers, risers, organizers, etc. While most of these products at least partially solve the storage space problem, most often by stacking elements on top of one another, these same products create problems of accessibility. Because most computer products and peripherals are communicatively connected with wires, these computers and peripherals have ports or connections for the wires. The recent proliferation of rechargeable and data sharing devices, such as digital cameras, cellular phones, personal digital assistants (PDA's), and the like, has compounded the problem of accessibility to the ports. Typically, the ports on computers are on the back of the computer, or in other locations of limited access, such as in a compartment of a central processing unit (CPU) computer tower, and the primary power source (i.e., electrical outlet) is commonly on a wall or floor adjacent to a back of the desk.

This orientation of ports and power sources (i.e., on the back of devices or along a wall or floor behind the desks, or other locations of limited access) creates problems when connecting or disconnecting devices to a computer. The user must pull the computer or device away from the back of the desk to access the ports. Additionally, the user may even have to pull the entire desk away from the wall, or crawl under the desk to access the primary power source.

Some attempts have been made to place power outlets and phone jacks in more accessible locations. For example, some hotel lamps now incorporate the power outlet and phone jacks into a base of the lamp. These lamps, while providing a more accessible outlet or jack, lack versatility, inasmuch as the outlet and/or jack cannot be changed without purchasing an entirely new lamp. Additionally, these lamps do not facilitate connecting peripheral devices to a computer.

### SUMMARY OF THE DISCLOSURE

Mounting receptacles are disclosed, each of which selectively receives an interchangeable hub having one or more ports therein, each port including an interface plug for plugging in electrical, electronic, and communications devices. Each of the mounting receptacles is installed in an opening in an article, such as an organizational device, and when a hub is selectively received in the mounting receptacle, the ports of the hub are accessible from an exterior of the organizational device, at an easy-to-reach location.

### BRIEF DESCRIPTION OF THE DRAWINGS

FIG. 1 is a front perspective view of a mounting receptacle constructed in accordance with the teachings of the disclosure;

FIG. 2 is a rear perspective view of the mounting receptacle of FIG. 1;

FIG. 3 is a front perspective view of a mounting receptacle similar to that shown in FIG. 1, and a hub that is selectively engageable with the mounting receptacle, shown prior to engagement of the hub with the mounting receptacle;

FIG. 4 is a front perspective view of the mounting receptacle of FIG. 1 and hub similar to that shown in FIG. 3, showing the hub and mounting receptacle partially engaged with one another;

FIG. 5 is a front perspective view of the mounting receptacle of FIG.1 and hub similar to that shown in FIG. 3, showing the hub and mounting receptacle fully engageable with one another;

FIG. 6 is a rear perspective view, partially cut away, of the fully-engaged mounting receptacle and hub of FIG. 5;

FIG. 6A is a rear perspective view, partially cut away, of a fully-engaged mounting receptacle and hub, and wherein the hub is provided with protective hoods over intersections between each spring clip associated with the hub and sidewalls of the hub;

FIG. 6B is a rear perspective view, partially cut away, of a fully-engaged mounting receptacle and hub, and wherein the sidewalls of the hub are provided with extensions adjacent each spring clip associated with the hub and sidewalls of the hub;

FIG. 7 is a side view of a spring clip for selectively securing a hub within a mounting receptacle, in accordance with the present disclosure;

FIG. 8 is a front perspective view of the spring clip shown in FIG. 7;

FIG. 9 is a rear perspective view of the spring clip shown in FIG. 7;

FIG. 10 is a side view of an alternate spring clip for selectively securing a hub within a mounting receptacle, in accordance with the present disclosure;

FIG. 11 is a perspective view of a component display stand having a first alternate mounting receptacle, in the form of an integral mounting receptacle, and a hub that is selectively engageable with the mounting receptacle, shown prior to engagement of the hub with the mounting receptacle;

FIG. 12 is a perspective view of the component display stand and hub of FIG. 11, showing the hub and mounting receptacle partially engaged with one another;

FIG. 13 is a perspective view of the component display stand and hub of FIG. 11, showing the hub and mounting receptacle fully engaged with one another;

FIG. 14 is a perspective view of a second alternate mounting receptacle and a hub that is selectively engageable with the mounting receptacle, shown prior to engagement of the hub with the mounting receptacle;

FIG. 14A is a perspective view, similar to that of FIG. 14, but showing an interchangeable hub provided with spring clips of the type shown in FIG. 10;

FIG. 15 is a perspective view of the mounting receptacle and hub of FIG. 14, showing the hub and mounting receptacle partially engaged with one another;

FIG. 16 is a perspective view of the mounting receptacle and hub of FIG. 14, showing the hub and mounting receptacle fully engaged with one another;

FIG. 17 is a bottom plan view of the fully engaged mounting receptacle and hub of FIG. 16;

FIG. 18 is a cross-section of the fully engaged mounting receptacle and hub of FIG. 16, taken along lines 18-18 of FIG. 16, and wherein the hub is provided with protective hoods over intersections between each spring clip associated with the hub and sidewalls of the hub;

FIG. 18A is a cross-section of a fully engaged mounting receptacle and hub, similar to FIG. 18, but showing an interchangeable hub as shown in FIG. 14A, provided with spring clips of the type shown in FIG. 10;

FIG. 19 is an environmental perspective view, with an exemplary organizational device in which a mounting receptacle and hub of the-present disclosure may be implemented shown in broken lines;

FIG. 20 is an environmental perspective view, with an alternate exemplary organizational device into which a mounting receptacle and hub of the present disclosure may be implemented shown in broken lines;

FIG. 21 is an exterior perspective view of a mounting receptacle and hub implemented in a device having at least one panel made of wood, simulated wood, or another wood-like material;

FIG. 22 is an interior perspective view of the mounting receptacle and hub of FIG. 21, as implemented in the device of FIG. 21; and

FIG. 23 is a bottom plan view of the mounting receptacle and hub of FIG. 21, as implemented in the device of FIG. 21.

### DETAILED DESCRIPTION

A mounting receptacle is provided that includes a faceplate having at least two legs and a cross bar. The cross bar may be along the top of the mounting receptacle, with the cross bar and side legs cooperating to at least partially define a window aperture. Additionally, a plurality of flanges extend from a rear surface of the faceplate and generally perpendicular to the rear surface of the faceplate. At least one of the flanges includes a feature for releasably securing a hub to the mounting receptacle. One such flange may extend from each of the side legs. Although directional terms, such as top, bottom, front, rear, upper, lower, beneath, below,under, over, and above, are used for reference purposes in the present disclosure, it will be understood that these terms are not limiting of the orientation of the structural elements disclosed.

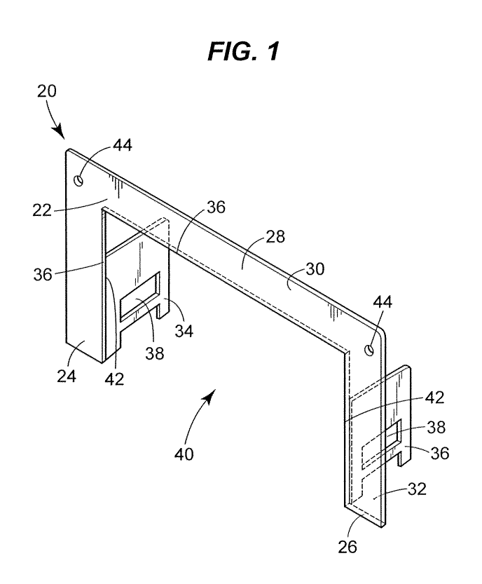

As shown in FIG. 1, the mounting receptacle 20 includes a generally flat and planar face plate 22. In this example, the face plate 22 is generally in the shape of a C, turned on its side. However, the face plate 22 need not be C-shaped, and can be any shape complementary to a hub to be selectively engaged with the mounting receptacle 20.

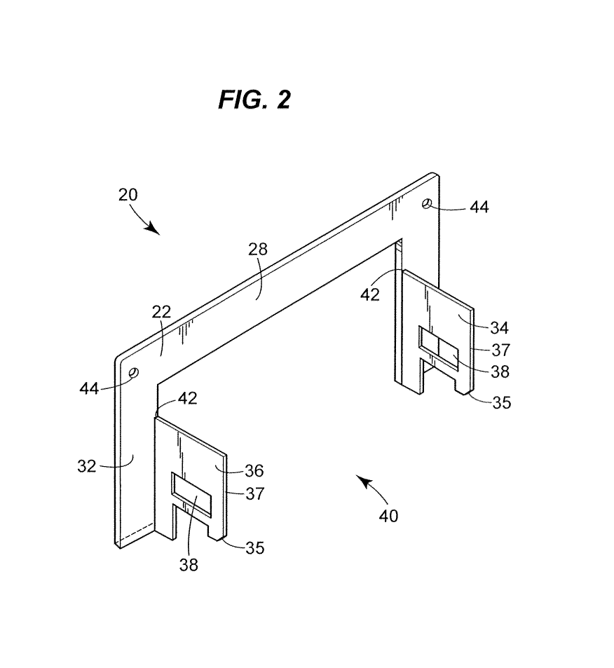

The face plate 22 includes first and second legs 24, 26 and a cross-bar member 28 extending between the first and second side legs 24, 26. A first surface 30 of the face plate 22 can be seen in the front perspective view of FIG. 1, and a second surface 32 of the face plate 22 can be seen in the rear perspective view of FIG. 2. A plurality of flanges 34, 36 extend from, and generally perpendicular to, the second surface 32, with one of the flanges 34 extending from the first leg 24, and another of the flanges 36 extending from the second leg 26. As seen in FIGS. 1 and 2, the flanges 34, 36 are spaced apart and parallel to one another. Each of the flanges 34, 36 is provided with at least one slot 38 therethrough for receiving a releasable securement device, in this case, a spring clip type device (not shown in FIG. 2) associated with an interchangeable hub, as explained in further detail below.

The cross-bar member 28 and the first and second side legs 24, 26 cooperate to at least partially define a window aperture 40. The flanges 34, 36 may be located along an innermost edge 42 of their respective legs 24, 26, on the second surface 32 of the face plate 22, such that the flanges 34, 36 are immediately proximate the window aperture 40.

The face plate 22 may include a plurality of openings 44 for receiving fasteners, such as screws, tacks, nails, or the like. The fasteners may be used to attach the mounting receptacle 20 to an inside surface of an article, such as an organizational device (not shown in FIG. 2), in the vicinity of an aperture provided within the article. Alternately, or additionally, the article may be provided with one or more internal channels (not shown) to securely receive the face plate 22 within the article, in the vicinity of an aperture provided within the article, or an adhesive may be applied to the portion of the first surface 30 of the face plate 22 which makes contact with the inside surface of the article in which the mounting receptacle is to be placed.

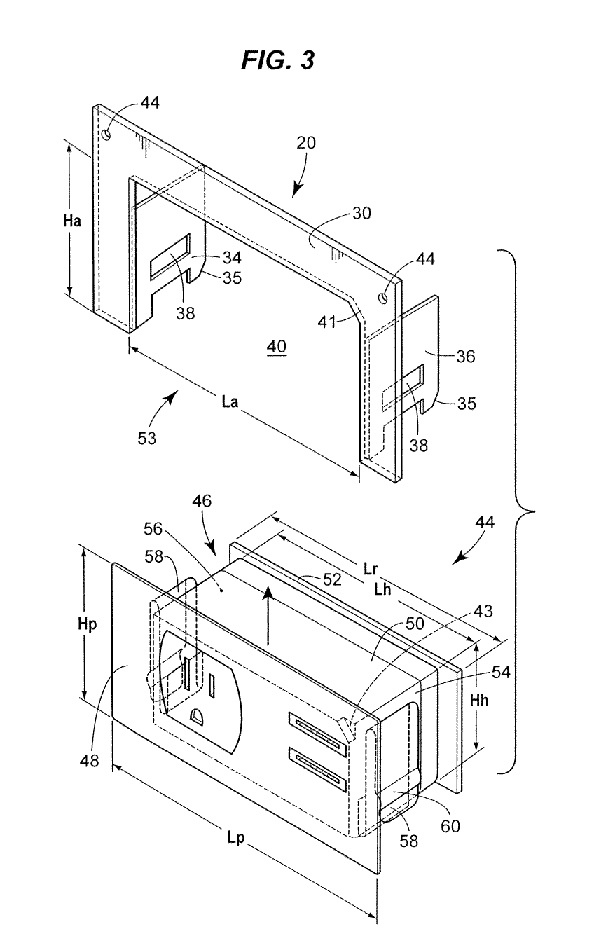

FIG. 3 is a front perspective view of a mounting receptacle 20, about to be engaged with an interchangeable hub 46. The hub 46 has a front hub plate 48, a hub body 50 extending rearwardly from the front hub plate 48, and a rear hub plate 52 disposed on a rear of the hub body 50, opposite and parallel to the front hub plate 48. The hub body 50 is of sufficient size and dimensional capacity to contain any requisite wiring or circuitry for any plugs or outlets provided on the hub 46, with the exception of any necessary connecting wires or extension cords extending from or through the rear hub plate 52, as discussed in more detail below. The height Hₕ and length Lₕ dimensions of the hub body 50 are sufficiently less than the corresponding dimensions Hₐ, Lₐ of the window aperture 40 provided in the mounting receptacle 20, to permit the hub body 50 to be removably received in the window aperture 40.

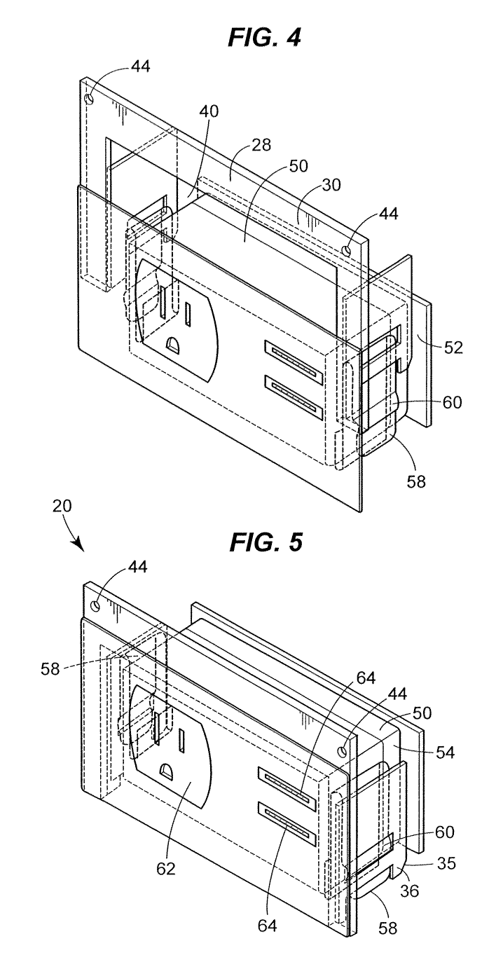

The front hub plate 48 has a larger length dimension Lₚ than the length dimension Lₐ of the window aperture 40. As shown in FIGS. 4 and 5, when the hub body 50 is received in the window aperture 40, the front hub plate 48 projects prominently of the first and second side legs 24, 26, and lies flush against the first surface 30 of the face plate 22. The openings 44 are located along a portion of the cross-bar member 28 that is not covered by the front hub plate 48 even when the hub 46 is fully engaged with the mounting receptacle 20. This enables use of the mounting receptacle 20 in an article in such a manner that the front hub plate 48 lies flush or substantially flush with an exposed surface of the article.

The hub 46 is inserted into the mounting receptacle 20 through an entry passage 53, such as may be provided by a space between a free end of the first and second legs 24, 26, and generally between the flanges 34, 36, until a rear side of the front hub plate 48 is proximate the first surface 30 of the mounting receptacle 20. The flanges 34, 36 generally guide the hub 46 into the window aperture 40 and remain substantially parallel and adjacent to first and second side walls 54, 56 of the hub body 50. As shown in FIGS. 2 and 3, each of the flanges 34, 36 may be provided with angled or contoured lower rear corner 35 to facilitate initial relative alignment of the rear hub plate 52 with a rear surface 37 of each of the flanges 34, 36.

The front hub plate 48 and rear hub plate 52 extend at least laterally past the first and second side walls 54, 56 of the hub body 50. The rear hub plate 52 is preferably spaced from the rear side of the front hub plate 48 a distance equal to or barely greater than the a depth of the flanges 34, 36. The rear hub plate 52 has a greater length Lᵣ dimension than the length dimension Lₐ of the window aperture 40, and therefore extends past rear edges of each of the flanges 34, 36. Thus, as the hub 46 is inserted into the window aperture 40, the flanges 34, 36 and face plate 22 of the mounting receptacle 20 are press fit or friction fit between the front hub plate 48 and the rear hub plate 52.

This press fit or friction fit facilitates maintaining perpendicularity or alignment of the hub 46 as it progressively engages with the mounting receptacle 20. When the hub 46 is fully engaged with the mounting receptacle 20, the front hub plate 48 provides adequate support and rigidity to the hub 46 to withstand at least some pushing force applied to the front hub plate 48 while inserting a plug into one or more of the ports 62, 64 provided on the hub 46. The press fit or friction fit also provides an advantage in that upon removal of a plug from one or more of the ports 62, 64 provided on the hub 46, the rear hub plate 52 cooperates with the flanges 34, 36 to provide adequate support and rigidity to the hub 46 to withstand at least some pulling force applied to the front hub plate 48 while removing a plug from one or more of the ports 62, 64 provided on the hub 46.

To facilitate and ensure proper alignment of the hub body 50 relative to the mounting receptacle 20, at least one corner of the window aperture 40 of the mounting receptacle 20 may be a slanted corner 41, and the hub body 50 may be provided with a complementary notch 43, as shown in FIG. 3. Alternately, the corner 41 and notch 43 hub body 50 may be contoured in a mutually complementary fashion.

The hub 46 includes a securement feature that cooperates with the slots 38 of the flanges 34, 36, in the form of securement devices 58, such as, for example, spring clips, provided on the side walls 54, 56 of the hub body 50. Each of the spring clips is provided with at least one outwardly-projecting ridge or bump 60, which is sized to be received within one of the slots 38. The closer the ridge or bump 60 is positioned to the apex 61 of the spring clip, the more difficult it is to withdraw the ridge or bump 60 from the slot 38.

The hub body 50 may be removed from the mounting receptacle 20 by gripping the front hub plate 48 and rear hub plate 52 in one hand, and rocking the hub body 50 while gently pulling the hub body 50 in a direction generally parallel to the first surface 30 of the mounting receptacle 20 and away from the entry passage 53. Such motion and pulling force is sufficient to overcome the securement of the engagement between each of the ridges or bumps 60 and the corresponding slot 38. The ridges or bumps 60 may be contoured to facilitate their removal from the corresponding slot 38 upon exertion of such motion and pulling force.

As discussed in greater detail below, as an alternate mechanism for facilitating removal of the hub body 50 from the mounting receptacle 20, extension portions 74 may be provided at the lower ends of the spring clip, which extend below the side walls 54, 56 of the hub body 50. Such extension portions may be pressed together to remove the ridge or bump 60 from the slot 38, thereby enabling removal of the hub 46 from the mounting receptacle 20 upon pulling the hub body 50 in a direction generally parallel to the first surface 30 of the mounting receptacle and away from the entry passage 53.

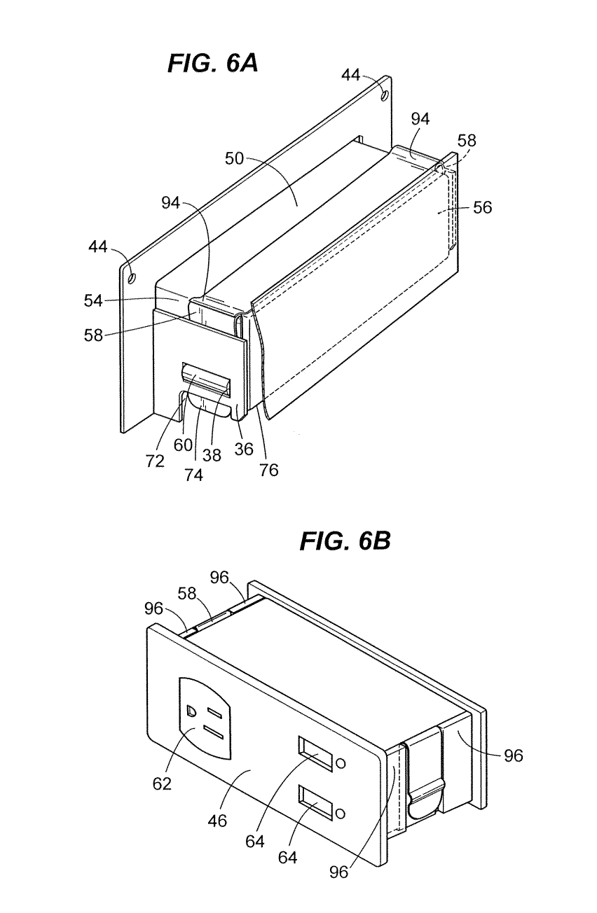

FIG. 4 is a front perspective view of the mounting receptacle 20 partially engaged with a hub 46. The hub 46 is shown as it is being inserted in the window aperture 40, with the securement devices 58 about to be secured by the flanges 34, 36, by engagement of the outwardly projecting ridge or bump 60 of the securement devices 56 with the slots 38 of the flanges 34, 36. In FIGS. 5 and 6, the hub 46 is shown fully engaged with the mounting receptacle 20, and the outwardly projecting ridge or bump 60 of one of the securement devices 58 is shown protruding through the slot 38 of the flange 36.

The hub 46 may include one or more ports 62, 64. The ports 62, 64 of a given hub 46 may be the same as one another, or different than one another. For example, one or more of the ports 62, 64 of the hub 46 may be an AC power supply, a USB connection port, a coaxial cable plug, an infrared receiver, a fiber-optic cable jack, a telephone jack, a high speed Ethernet connection jack, an RCA jack, S-video jack, etc. Also, where the ports 62, 64 are both of the same type, the ports 62, 64 may have the same orientation as one another or may have different orientations from one another within a given hub 46.

Any wiring or circuitry required to allow devices plugged into any of the ports 62, 64 to communicate with one or more wires (not shown) leading from the hub 46 to, for example, a power supply, a computer, or another device, is contained within the hub body 50, with the exception of extension cords or other wiring as may be required to connect the hub 46 to a power supply or other peripheral, jack, or apparatus, which may extend from a top, rear, and/or bottom of the hub 46.

The hub 46 is removable and interchangeable with similar hubs 46. Other hubs 46 having different selections and/or configurations of ports 62, 64, but substantially the same outer dimensions and securement devices, may be placed into the mounting receptacle 20. The modular nature of the hubs 46 facilitates interchanging hubs 46 when different requirements, such as technological advancements, make alternative ports 62, 64 within the hub 46 desirable within a given article, such as an organizational device.

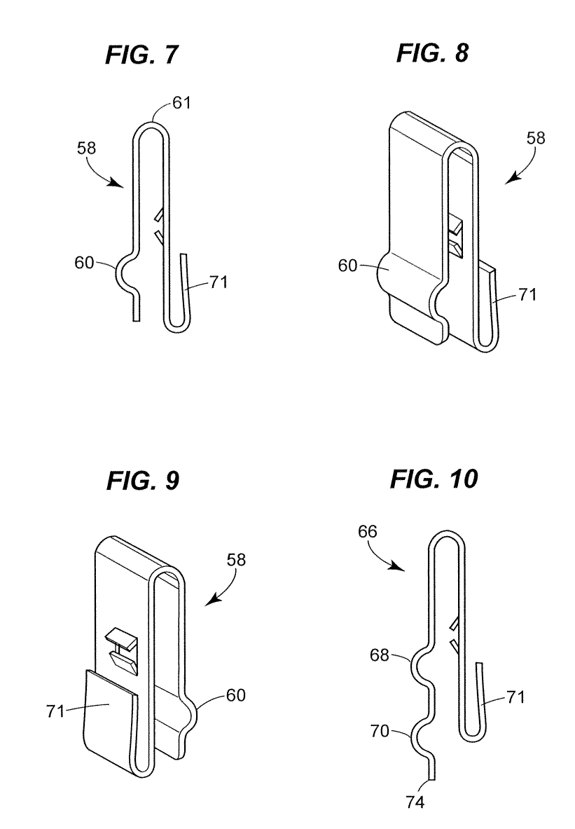

FIGS. 7-9 show one form of securement device 58, namely a spring clip, which is mountable to either of the side walls 54, 56 of the hub body 50. FIG. 10 shows an alternate securement device 66, also in the form of a spring clip, which is provided with an upper ridge or bump 68 and a lower ridge or bump 70. The upper ridge or bump 68 is received in the slot 38 of one of the flanges 34, 36 of the mounting receptacle 20 when the hub 46 is fully engaged with the mounting receptacle 20. As best shown in FIG. 2, each of the flanges 34, 36 is provided with a notched, downwardly-open receiving opening 72. The lower ridge or bump 70 of the securement device 66 is received in the notched receiving opening 72 when the hub 46 is fully engaged with the mounting receptacle 20, effectively bounding an elongate portion 72 of the flange 34 or 36 which defines a lower edge of the slot 38 and an upper edge of the receiving opening 72.

The securement devices 58, 66, or spring clips, each have an extension portion 74 at a free end, which extends beyond the ridges or bumps 60, 70. When received on a hub 46, the extension portions 74 of the securement devices 58 or 66 on either side of the hub 46 may extend beyond a bottom 76 of the hub 46. When fully engaged with a mounting receptacle 20, the extension portions 74 of the securement devices 58 or 66 may still be accessible, so that an individual can squeeze the spring clips 58 or 66 inwardly, toward one another, thereby withdrawing or substantially withdrawing the ridges or bumps 60 or 68 from the slots 38 of the flanges 34, 36, to facilitate disengagement of the hub 46 from the mounting receptacle 20.

Each of the securement devices 58 or 66 is secured to the side walls 54, 56 of the hub body 50 by a tongue 71 received in a complementary tongue receiving slot 73 provided in each of the side walls 54, 56. Each of the side walls 54, 56 is further provided with an outwardly-projecting post 75. Each of the securement devices 58, 66 is provided with a post-receiving aperture 78. The post-receiving aperture 78 may be formed at the time of manufacture by cutting, punching, or otherwise forming one or more biting flanges forming teeth 79 in the securement device 58, 66, each of such teeth 79 remaining connected to the securement device 58, 66 along one edge thereof, such that each of such teeth 79 is in immediate proximity to the post-receiving aperture 78. The teeth 79 may bite into the post 75 to help retain the securement device 58 or 66 on the hub body 50.

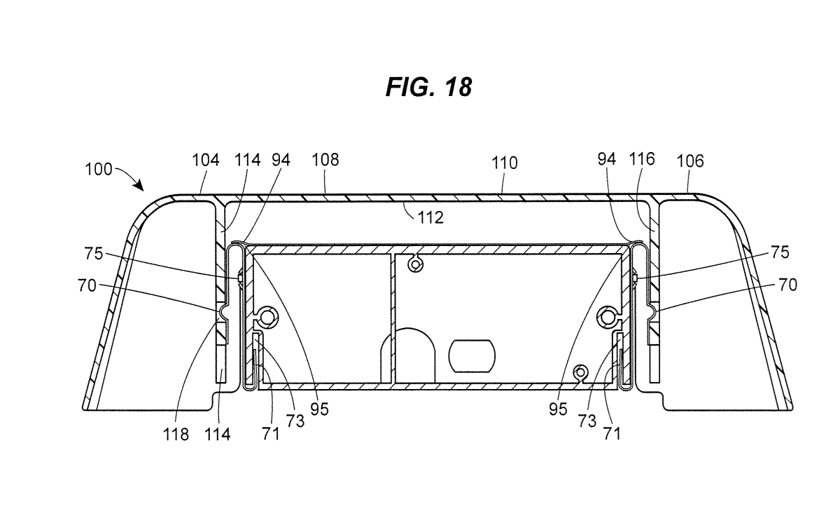

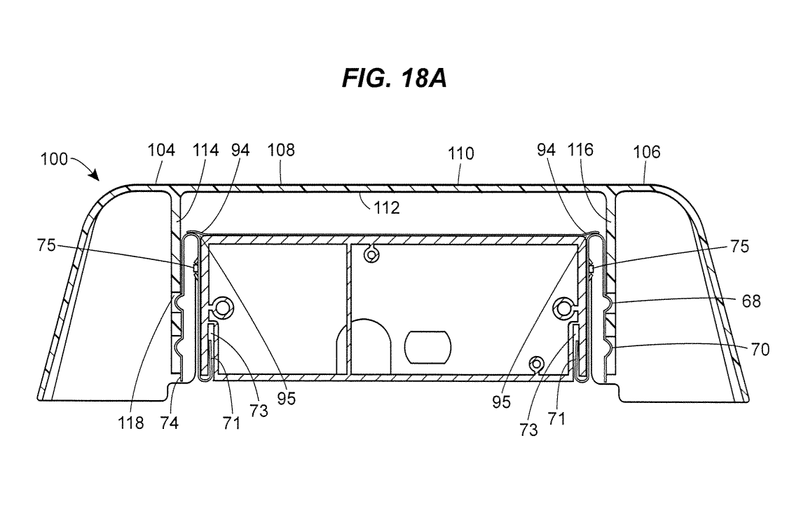

It is desirable to protect the post 75 from damage so as to preserve the integrity of the retention of the securement devices 58 or 66 on the hub body 50. One manner of protecting the post 75, as shown in FIGS. 6A and 18, is to provide a hood 94 over an exposed region 95 between the securement device 58 or 66 and the respective side wall 54, 56 of the hub body 50. An alternate manner of protecting the post 75, as shown in FIG. 6B, is to provide extensions 96 of the side walls 54, 56 adjacent the securement devices 58 or 66.

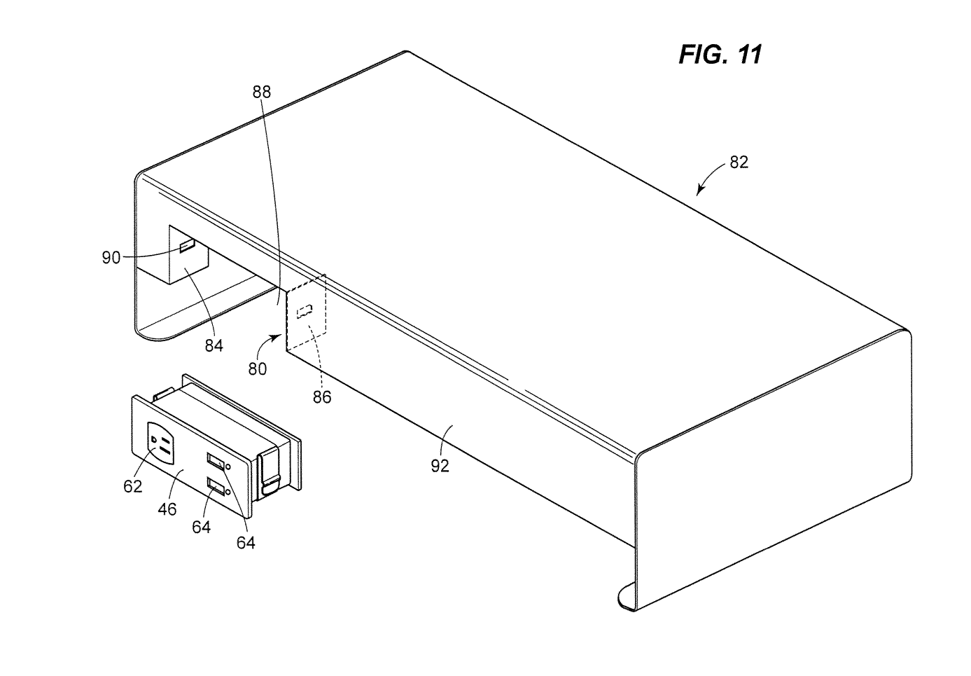

FIG. 11 shows an alternate mounting receptacle 80 and a hub 46 about to be engaged with one another. The mounting receptacle 80 is formed integrally with an organizational device 82. The mounting receptacle 80 includes a first flange 84, a second flange 86, and window aperture 88. The mounting receptacle 80 is provided adjacent a free edge of the organizational device 82, such that a bottom of the window aperture 88 and a lower edge of each of the flanges 84, 86 are open and accessible from an exterior of the organizational device 82, facilitating insertion of the hub 46 from a position beneath the window aperture 88.

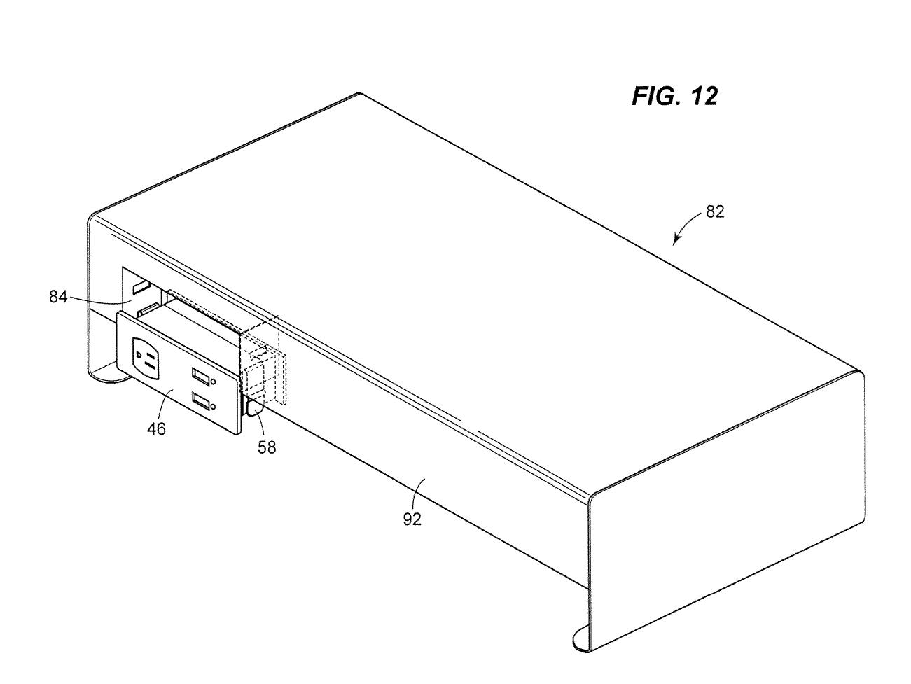

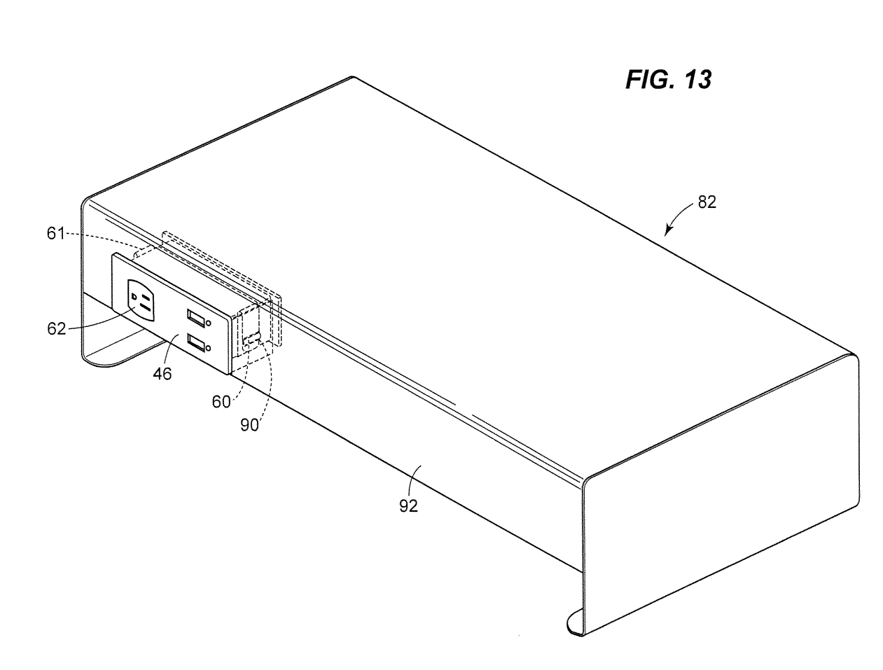

Each of the flanges 84, 86 is provided with a slot 90 sized to accommodate an outwardly-projecting ridge or bump 60 of a spring clip or other resilient securement device 58 provided on the hub 46. As illustrated in FIGS. 12 and 13, as the hub 46 is engaged with the mounting receptacle 80, the front hub plate 48 projects prominently and lies immediately adjacent an exposed surface 92 of the organizational device 82. The rear hub plate 52 extends anteriorly to (relative to the exposed surface 92), and immediately adjacent, rear edges of each of the flanges 84, 86. When the hub 46 is fully engaged with the mounting receptacle 80, the ridge or bump 60 provided on each of the spring clips provided on the hub 46 is received in the complementary slot 90 of the respective flanges 84, 86.

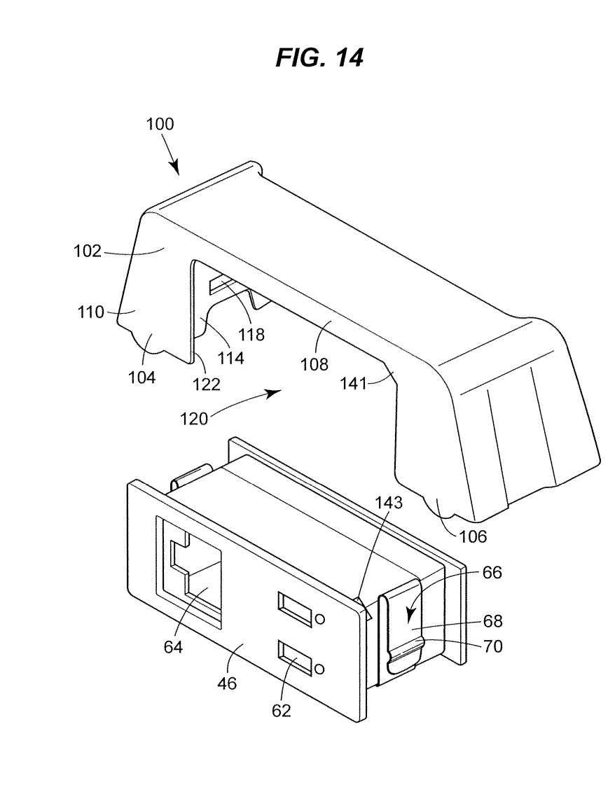

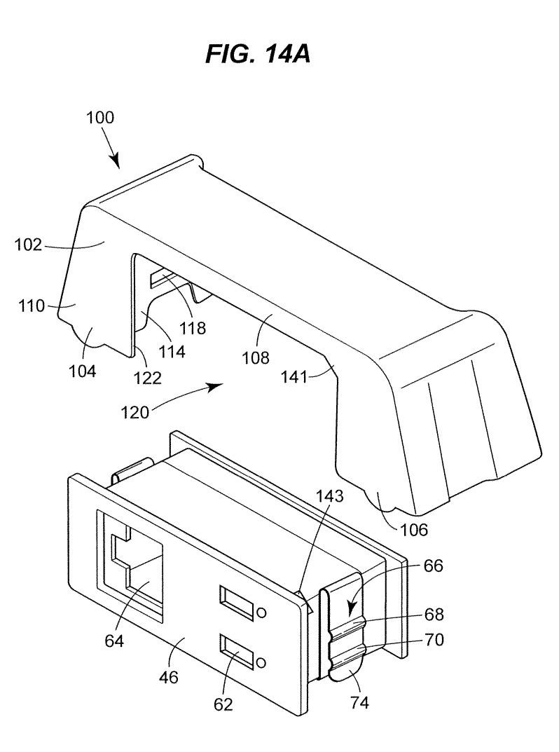

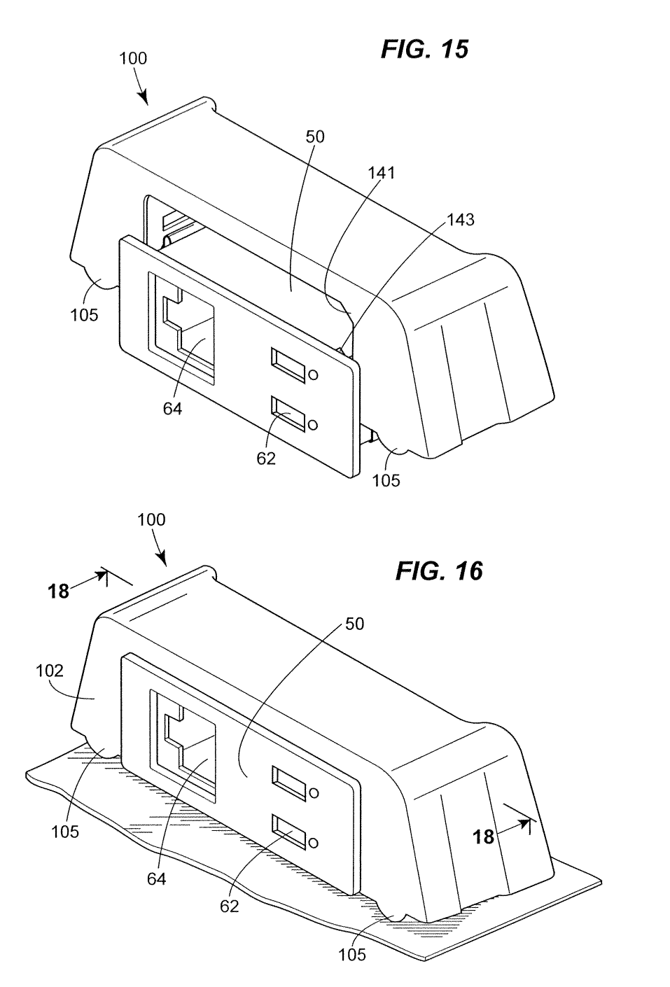

Turning to FIGS. 14-20, a second alternate mounting receptacle 100 is shown. The mounting receptacle 100 may be made of injection molded plastic or other suitable material. The mounting receptacle 100 has a face plate 102, generally in the shape of a C, turned on its side. The mounting receptacle 100 is sufficiently sturdy and rigid for use as a free-standing mounting receptacle 100 to receive an interchangeable hub 46, and support the hub 46 on a desk, countertop, or other work surface.

Like the mounting receptacle 20, described above, the face plate 102 includes first and second legs 104, 106 and a cross-bar member 108 extending between the first and second side legs 104, 106. Each of the side legs may further include a pedestal or foot 105 to raise the face plate 102 up off the work surface, and to impart an upward tilt to the front hub plate 48 of the hub 46, such that the ports 62, 64 are displayed at an angle relative to the work surface. This angled orientation of the ports 62, 64 relative to the work surface facilitates insertion of plugs into the ports 62, 64 by providing increased room between an underside of such plugs and the top of the work surface to accommodate a person's fingers.

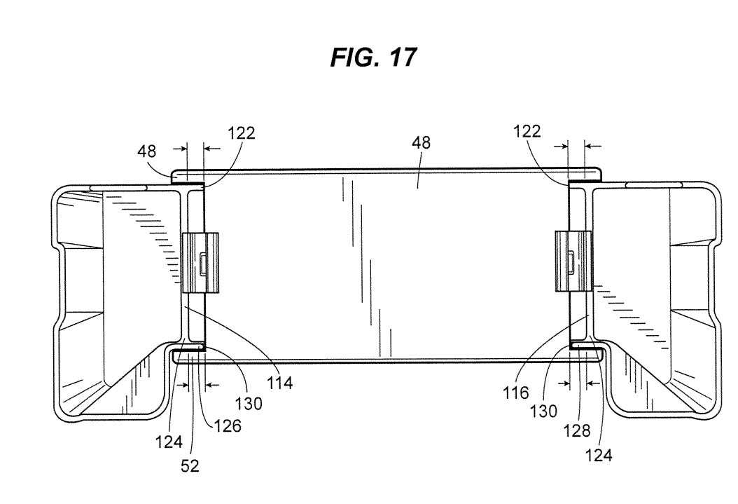

A first surface 110 of the face plate 102 can be seen in the front perspective view of FIG. 14. A second surface 112 of the face plate 112 can be seen in the cross-sectional view of FIG. 18. A plurality of flanges 114, 116 extend from, and generally perpendicular to, the second surface 112. One of the flanges 114 extends from the first leg 104, and another of the flanges 116 extends from the second leg 106. As seen in the bottom view of FIG. 17 and the cross-sectional view of FIG. 18, the flanges 114, 116 are spaced apart and parallel to one another. Each of the flanges 114, 116 is provided with at least one slot 118 therethrough for receiving a ridge or bump 60 of a releasable securement device 66, such as a spring clip type device, associated with an interchangeable hub 46.

A window aperture 120 is provided in the mounting receptacle 100. The window aperture 120 is defined by the cross-bar member 108 and the first and second side legs 104, 106. The flanges 114, 116 are spaced laterally outwardly of an innermost edge 122 of their respective legs 104, 106, on the second surface 112 of the face plate 102. Thus, the flanges 114, 116 are spaced laterally outwardly of the window aperture 120.

As shown in FIG. 17, at a rear end 124 of each of the flanges 114, 116, anterior legs 126, 128 are provided. The anterior legs 126, 128 extend parallel to the front legs 104, 106, and perpendicular to the flanges 114, 116. Each of the anterior legs 126, 128 has an innermost edge 130, which is spaced laterally inwardly of the flanges 114, 116. The innermost edges 130 of the anterior legs 126, 128, and the innermost edges 122 of the front legs 104, 106 make contact with the sidewalls 54 of the hub body 50 of the interchangeable hub 46 when the hub 46 is at least partially engaged with the mounting receptacle 100.

When the hub 46 at least partially engages the mounting receptacle 100, the rear hub plate 52 rides against the anterior legs 126, 128, and the front hub plate 48 rides against the first surface 110 of the front legs 104, 1 06. The relative arrangement of the front legs 104, 106, the anterior legs 126, 128, and the depth of the flanges 114, 116 complement the front hub plate 48, the rear hub plate 52, the sidewalls 54 of the hub body 50, and the spring clips 58 provided on the sidewalls 54, to ensure perpendicularity of the hub 46 and the mounting receptacle 100 as they are engaged with one another. When fully engaged, the uppermost ridge or bump 68 of each of the spring clips 58 are received in the respective slots 118 in the flanges 114, 116.

When it is desired to remove the interchangeable hub 46 from the mounting receptacle 100, the hub 46 may be disengaged by gripping the front hub plate 48 and rear hub plate 52 in one hand, and rocking the hub body 50 while gently pulling the hub body 50 in a direction generally parallel to the first surface 110 of the mounting receptacle 100 and away from an entry passage of the window aperture 120. Such motion and pulling force is sufficient to overcome the securement of the engagement between each of the ridges or bumps 60 and the corresponding slot 118. The ridges or bumps 60 may be contoured to facilitate their removal from the corresponding slot 118 upon exertion of such motion and pulling force.

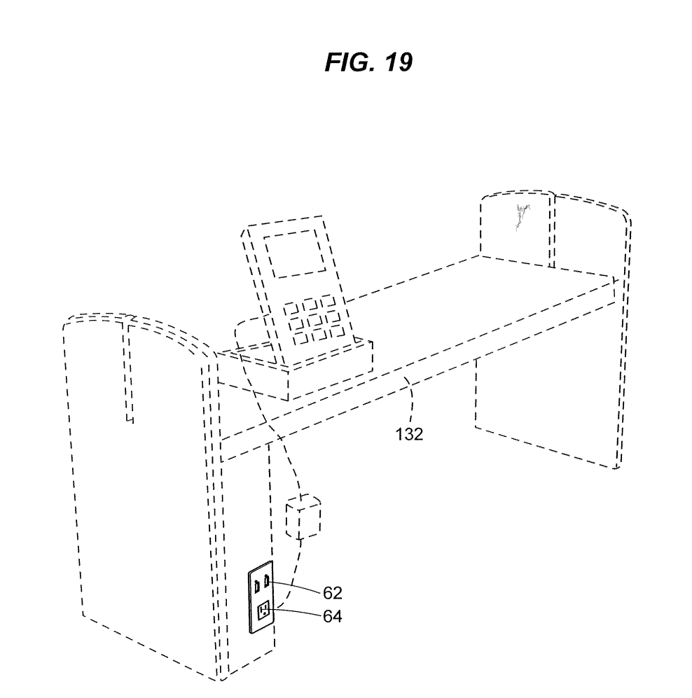

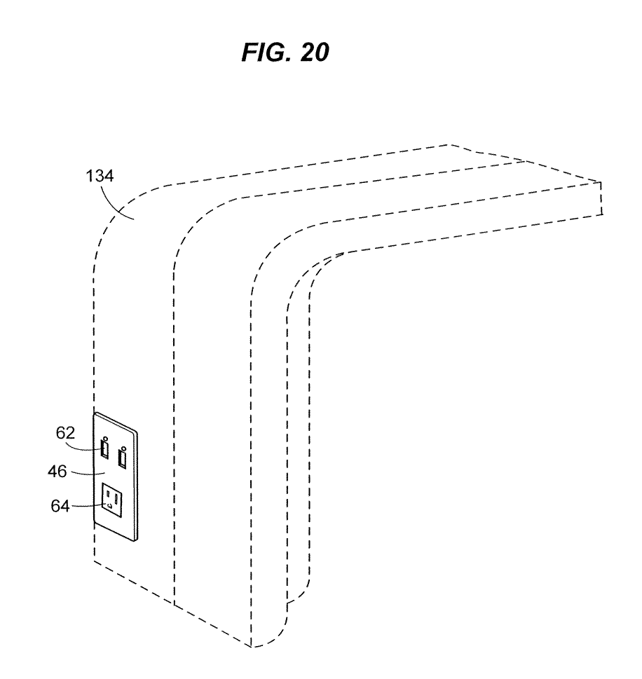

Turning to FIGS. 19 and 20, different exemplary organizational devices are shown which can accommodate mounting receptacles 20 for interchangeable hubs 46 of the present disclosure. As shown in FIG. 19, an organizational device 132 may be provided with a mounting receptacle (not shown) in the immediate vicinity of an aperture in the front of the organizational device 132, receiving a hub 46 with ports 62, 64 which are accessible from the front of the organizational device 132. FIG. 20 shows an organizational device 134 provided with a mounting receptacle (not shown) in the immediate vicinity of an aperture in a side of the organizational device 134, receiving a hub 46 with ports 62, 64 which are accessible from the side of the organizational device 132.

The hub 46 itself may be quickly and easily replaced if a different selection or configuration of ports 62, 64 is required. For example, a user may require a telephone jack and a power supply in a particular hub 46. If the user subsequently purchases a peripheral device that requires a USB port and no longer has a need for a telephone jack, only a new hub 46 having a USB port need be purchased instead of an entirely new organizational device 132, 134.

Using a mounting receptacle 20 of the present disclosure, wires may be routed from the hub 46 to a connection through an associated organizational device 66, 68 on a semi-permanent basis. This feature facilitates substantially inconspicuous organization of wires and prevents fouling and entangling of wires as peripheral devices are added or replaced.

The mounting bracket 20 may also be interchangeable with other organizational devices 66, 68. For example, the mounting bracket 20 installed in a particular organizational device 66 may be removed and placed in another organizational device 68 (e.g., a stand having a shelf) in the event the user decides that a particular organizational device 68 would be more beneficial than a previous organizational device 66, in conjunction with components requiring the same selection and configuration of ports 62, 64.

Alternatively, the user may decide that a new color or finish for the organizational device 132, 134 is more appropriate for a particular environment. This interchangeability feature provides the user with a significant savings, inasmuch as only the relatively inexpensive new organizational device 132, 134 needs to be obtained by a user who already possesses a hub 46 and moutning receptacle 20. The relatively more expensive hub 46 may be reused. If the mounting receptacle 20 itself is removable from the organizational device 132 or 134, then the mounting receptacle 20 may also be transferred to another compatible organizational device 132 or 134.

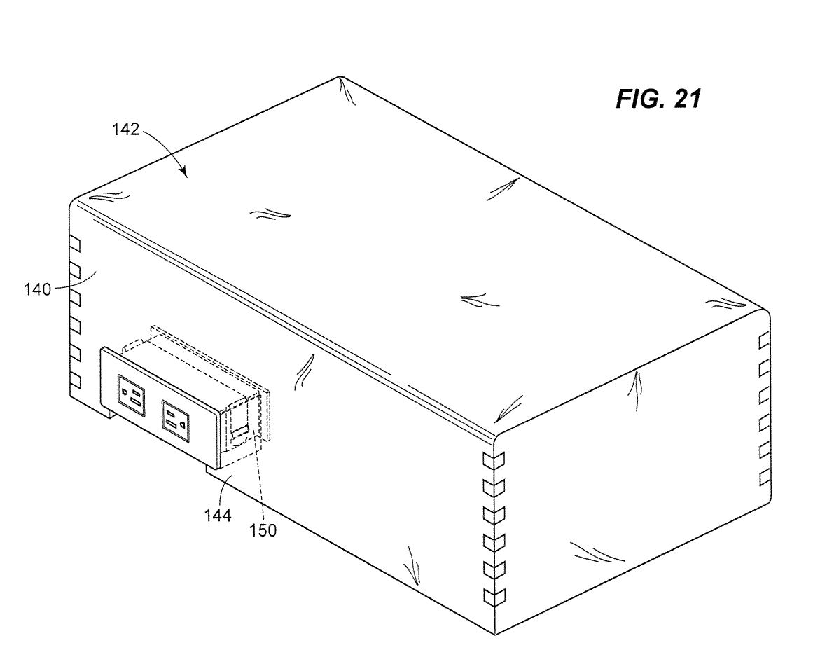

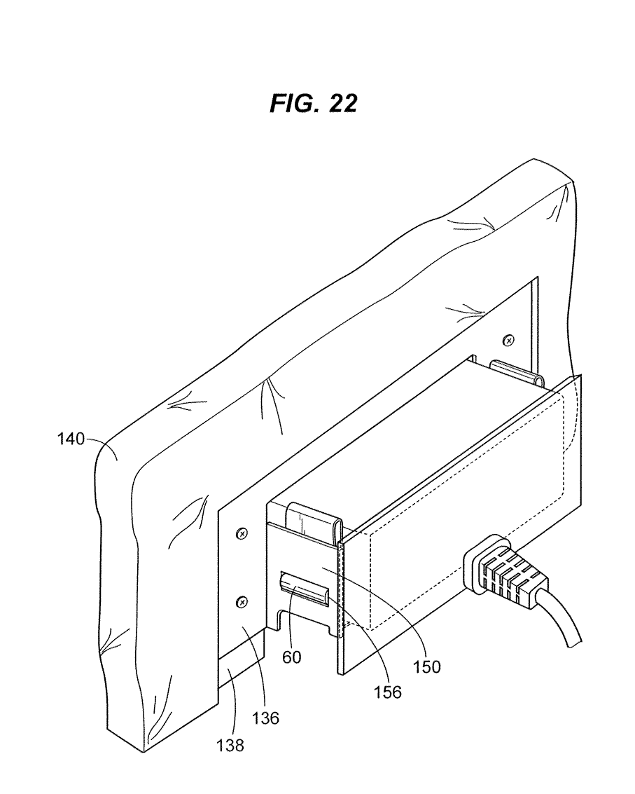

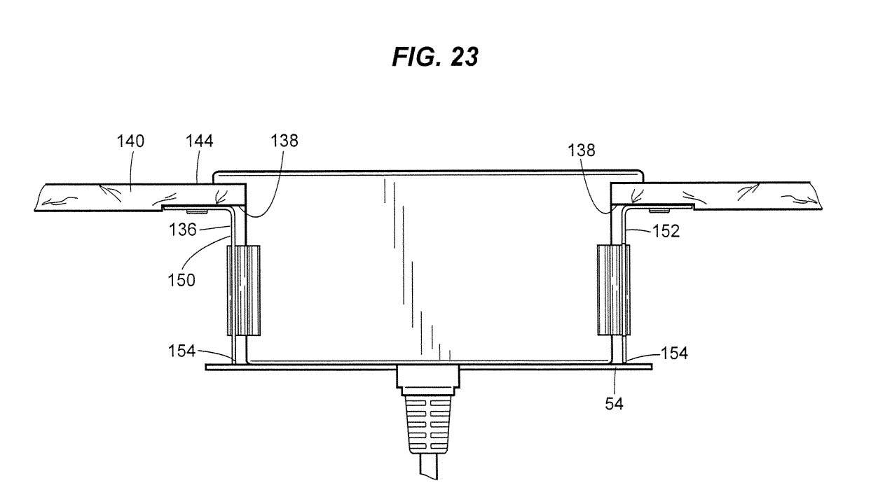

FIGS. 21-23 illustrate yet another version of a mounting receptacle for releasably and securely mounting an interchangeable hub 46 within an article. The mounting receptacle 136 of this embodiment is similar to the mounting receptacle 20, described above. However, as shown in FIG. 23, the mounting receptacle 136 is mounted to an interior surface 138 of a wall 140 of the article 142, and the front hub plate 48 of the hub 46 is disposed against an exposed surface 144 of the wall 140. Thus, a first surface 146 of a face plate 148 of the mounting receptacle 136 is spaced from the front hub plate 48 of the hub 46 when the hub 46 is engaged with the mounting receptacle 136. Therefore, to accommodate hubs 46 having sidewalls 54 of the same depth as accommodated by the mounting receptacle 20, the depth of each of flanges 150, 152 of the mounting receptacle 136 is relatively less than the depth of the flanges 34, 36 of the mounting receptacle 20.

By contrast, as shown in FIGS. 4 and 5 and described above, the front hub plate 48 of the hub 46 lies flush against the first surface 30 of the face plate 22 of the mounting receptacle 20, with openings 44 located along a portion of the cross-bar member 28 that is not covered by the front hub plate 48, even when the hub 46 is fully engaged with the mounting receptacle 20, enabling use of the mounting receptacle 20 in an article with the front hub plate 48 lying flush or substantially flush with an exposed surface of the article.

The article 142 may be made of wood or a wood-like material. The interior wall 138 may be a recessed portion of a wall of the article 142. As in the previous embodiments, the mounting receptacle 136 cooperates with the rear hub plate 52 to maintain perpendicularity or alignment as the hub 46 is engaged with the mounting receptacle 136. More specifically, the rear hub plate 52 rides along a rear edge 154 of each of the flanges 150, 152 during insertion of the hub 46 into the mounting receptacle, until the ridge or bumps 60 of the spring clips or other securement devices provided on the hub 46 are received in slots 156 in the flanges 150, 152. The front hub plate 48 and rear hub plate 52 form a press fit with the wall 140 and the mounting receptacle 136.

Variations may be made to the embodiments disclosed herein that are still considered within the scope of the appended claims. Also, as discussed above, while relative directional modifiers are used herein, this disclosure is not intended to be limited to particular orientations of the mounting receptacle and hub arrangements disclosed.

What is claimed is:

1. A mounting receptacle for removably receiving a hub, said mounting receptacle comprising:
a face plate having
a first leg;
a second leg; and
a cross-bar member extending between the first and second legs, said cross-bar member, first and second legs defining a window aperture; and
a flange extending from each of the first and second legs.

2. The mounting receptacle of claim 1, wherein the face plate of the mounting receptacle includes a first surface and a second surface, and both of the flanges extend from the second surface.

3. The mounting receptacle of claim 2, wherein at least one of the flanges includes a slot therethrough.

4. The mounting receptacle of claim 3, in combination with a hub received in the window aperture, said hub having at least one plug-receiving port therein.

5. The mounting receptacle and hub combination of claim 4, wherein the hub includes at least one securement device for selectively securing the hub within the mounting receptacle.

6. The mounting receptacle and hub combination of claim 5, wherein the securement device includes a ridge which is removably received within the slot of the at least one flange.

7. The mounting receptacle and hub combination of claim 4, wherein each of the at least one securement devices includes a tongue received in a respective tongue-receiving slot provided in a body of the hub.

8. The mounting receptacle and hub combination of claim 5, wherein the hub includes a body having a front hub plate, a rear hub plate, a first side wall, and a second side wall, said front hub plate and said rear hub plate extending laterally past each of the first and second side walls and being spaced from one another so as to receive the front face and flanges of the mounting receptacle between the front hub plate and rear hub plate.

9. The mounting receptacle and hub combination of claim 8, wherein each of the at least one flanges includes a lower rear edge which is at least one of angled or contoured to facilitate insertion of the hub in the mounting receptacle.

10. The mounting receptacle and hub combination of claim 1, wherein the cross-bar member intersects with at least one of the first leg and second leg at a corner which is at least one of slanted or contoured.

11. The mounting receptacle and hub combination of claim 10, wherein the hub includes a body having a front hub plate, a rear hub plate, a first side wall, and a second side wall, said front hub plate and said rear hub plate extending laterally past each of the first and second side walls and being spaced from one another so as to receive the front face and flanges of the mounting receptacle between the front hub plate and rear hub plate, and the hub body includes a notch which is complementary to the corner so as to receive the slanted or contoured corner therein.

12. The mounting receptacle of claim 1 further including a plurality of apertures through the face plate to receive fasteners therein for securing the mounting receptacle to an article.

13. The mounting receptacle of claim 1, further including at least one pedestal provided along a lower edge of at least one of the first and second legs, said at least one pedestal imparting a tilt to the mounting receptacle when placed on a work surface.

14. A mounting receptacle in combination with an interchangeable hub, said mounting receptacle comprising
a face plate having
a first leg;
a second leg; and
a cross-bar member extending between the first and second legs, said cross-bar member, first and second legs defining a window aperture; and
a flange extending from each of the first and second legs; and said interchangeable hub comprising
a body having
a front hub plate;
a rear hub plate;
a first side wall; and
a second side wall, said front hub plate and said rear hub plate extending laterally past each of the first and second side walls and being spaced from one another so as to receive the front face and flanges of the mounting receptacle between the front hub plate and rear hub plate; and
a securement device extending from each of the first and second side walls, each of said securement devices selectively engaging one of said flanges of the mounting receptacle.

15. The mounting receptacle and interchangeable hub combination of claim 14, wherein each of the securement devices includes a tounge received in a respective tongue-receiving slot provided in the body of the interchangeable hub.

16. The mounting receptacle and interchangeable hub combination of claim 15, wherein each of the first and second side walls includes an outwardly-projecting post and each of the securement devices includes a post-receiving aperture therethrough, each of said posts extending through a respective one of the post-receiving apertures.

17. The mounting receptacle and interchangeable hub combination of claim 16, each of the post-receiving apertures having at least one biting flange in immediate proximity thereto, said at least one biting flange biting into the post received in the post-receiving aperture.

18. The mounting receptacle and interchangeable hub combination of claim 16, wherein the hub body is provided with a hood extending over each of the securement devices and the respective side wall of the interchangeable hub.

19. The mounting receptacle and interchangeable hub combination of claim 14, wherein each of the flanges is provided with a slot therethrough, and each of the securement devices includes a ridge which is removably received within the slot of the respective flange with which the securement device is engaged.

20. The mounting receptacle and interchangeable hub combination of claim 14, wherein each of the flanges includes a lower rear edge which is at least one of angled or contoured to facilitate insertion of the hub in the mounting receptacle.

21. The mounting receptacle and interchangeable hub combination of claim 14, wherein the cross-bar member intersects with at least one of the first leg and second leg at a corner which is at least one of slanted or contoured.

22. The mounting receptacle and interchangeable hub combination of claim 21, wherein the hub body includes a notch which is complementary to the corner so as to receive the slanted or contoured corner therein.

23. A mounting receptacle for removably receiving an interchangeable hub having at least one port therein to receive a plug, said mounting receptacle provided in an opening in a surface of an article and, when an interchangeable hub is removably received in the mounting receptacle, the port of said interchangeable hub is accessible from an exterior of the article.

24. The mounting receptacle of claim 23, wherein the mounting receptacle includes a face plate having first and second sides and wherein at least one flange extends from the second side, said at least one flange being selectively engageable with a resilient securement device provided on an interchangeable hub received in the mounting receptacle.

25. The mounting receptacle and interchangeable hub combination of claim 24, wherein the at least one flange includes a slot and the resilient securement device includes a ridge which is removably receivable within the slot of the respective flange with which the securement device is engageable.
